(19) United States
(12) Patent Application Publication
(10) Pub. No.: US 2008/0158567 A1
(43) Pub. Date: Jul. 3, 2008

(54) Quantum messaging device

(76) Inventor: Douglas Michael Snyder, Los Angeles, CA (US)

Correspondence Address: Douglas M. Snyder, P.O. Box 551, Beverly Hills, CA, 90213, US

(21) Appl. No.: 11/983,713

(22) Filed: Nov. 13, 2007

Related U.S. Application Data
(60) Provisional application No. 60/877,509, filed on Dec. 28, 2006.

(51) Int. Cl. G01B 9/02

(52) U.S. Cl. 356/450

(57) ABSTRACT

Through systematically varying whether the path of a photon emitted into an interferometer is or is not specified, one can create a binary message and send it from one location to another where this message cannot be known in the intervening space between where the message is constructed and where it is received. There are no relevant differences as regards the photons that bear the message in the intervening space between where the message is constructed and where it is received that allows the message to be known in this “middle” area. Nonetheless, because of systematically varying whether the path of a photon emitted into an interferometer is specified at the interferometer's entrance, the distributions of photons after they exit the interferometer differ depending on whether the particular path into which the photon is emitted is specified at the interferometer's entrance. Binary values are associated with the two distinct distributions.

### CROSS-REFERENCE TO RELATED APPLICATIONS

Application for Provisional Patent filed by Douglas Michael Snyder for Quantum Signaling Device Where the Probability of Signal Detection is Low [Application Number US60/877,509], filed Dec. 28, 2006.

Disclosure Document for Quantum Signaling Device Where the Probability of Signal Detection is Low [Application Number 606955], filed Oct. 6, 2006.

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISK APPENDIX

Not Applicable

### BACKGROUND OF THE INVENTION

Following is a description of information known to me that is related to my invention. Also, this description references specific problems involved in the prior art (and accompanying technology) to which my invention is drawn.

The Quantum Messaging Device (QMD) uses, among others, the quantum mechanical principle of superposition of quantum states, including the possibility of constructive and destructive interference arising from this superposition (principle 1). Both constructive and destructive interference are evident in the classic double-slit experiment in quantum mechanics where the double-slit screen is fixed in place and where one obtains interference with the passage of particles through it (FIG. 1). In the classic double-slit experiment, the wave function for the particle passing through the double-slit screen is:

Ψₜₒₜₐₗ=1/√2[ψ_{L}+ψ_{R}], [1]

where ψ_{L} and ψ_{R} represent the component wave functions associated with slits L and R. The distribution of the particles at the detection screen demonstrates interference and is given by P where:

P=|Ψₜₒₜₐₗ|²=½[|ψ_{L}|²+|ψ_{R}|²+ψ_{L}*ψ_{R}+ψ_{R}*ψ_{L}] [2]

Constructive interference is found at the peaks of the particle distribution, and destructive interference is found at the valleys of the particle distribution.

In contrast, if, the double-slit screen is placed on rollers, one loses interference and obtains which-way information concerning the passage of the particles through the double-slit screen (FIG. 2). The wave function for the particle when the double-slit screen on rollers is either:

Ψ_{particle}=ψ_{L} [3]

or

Ψ_{particle}=ψ_{R} [4]

The distribution at the detection screen does not demonstrate interference and is given by P where:

P=|ψ_{L}|²+|ψ_{R}² [5].^{1,2,3,4}

Normalizing the distribution in eqn. 5 yields:

P=½|ψ_{L}|²+ 1/2|ψ_{R}|² [5a]

A second major principle of quantum mechanics used in the QMD is that the quantum mechanical wave function provides the basis for making probabilistic predictions of measurement outcomes (principle 2). Indeed, P in eqns. 2 and 5a are the probabilities that a specific particle will be found at different locations on the detector screen. Also, as noted above in the classic double-slit experiment, the wave function for the particle passing through the double-slit screen is:

Ψₜₒₜₐₗ=1/√2[ψ_{L}+ψ_{R}], [1]

Expanding the right side of eqn. 1 results in:

Ψₜₒₜₐₗ=1/√2ψ_{L}+1/√2ψ_{R}, [6]

Taking the square of 1/√2 in either term on the right side of eqn. 1 yields the probability that a measurement of the path taken by the particle from the double-slit screen to the detection screen will be found in either path L or path R, namely ½.

In comparison, as noted, where the double-slit screen is placed on rollers, the distribution at the detection screen does not demonstrate interference and is given by P where:

P=½|ψ_{L}+½|ψ_{R}|² [5a]

This distribution function indicates that where the double-slit screen is placed on rollers, it is equally likely that a particle would have been found to take either path L or path R if its path were measured. ½ of the particles passing through the double-slit took path L and ½ of the particles took path R.

In quantum mechanics, in between making measurements (i.e., the initial and final states of a system), it is generally not known in a precise way what is happening to the system (principle 3). This statement is a third major principle of quantum mechanics used in the QMD. If one could know what is happening to the system precisely, one would be able to predict precisely what the measurement result on the system would be, as can be done for example in classical physics. Quantum mechanics is in its nature only capable of probabilistic predictions. This probabilistic character of prediction in quantum mechanics was confirmed in experiments involving the entanglement of separated particles where the classical alternative to the probabilistic predictions of quantum mechanics was not supported by empirical test that stemmed from the theoretical work of Einstein, Podolsky, and Rosen.^{5,6,7,8}

More specifically, work on issues arising out of EPR (i.e., the theoretical work of Einstein, Podolsky, and Rosen) led to empirical tests on whether the probabilistic character of prediction in quantum mechanics indeed reflected physical reality or if instead a classical theory where processes developed in a deterministic manner in physical reality could account for the results obtained in EPR. This work showed that a classical theory where processes developed in a deterministic manner could not account for the results that EPR showed were possible in quantum mechanics and that were empirically verified.^{5,6,7,8} Rohrlich noted in the light of this research, “Local hidden variables theory is dead.”⁹ Quantum mechanics indicates, and empirical research supports the principle, that nothing is known between measurements concerning various physical systems of concern other than what can be derived from the wave function that describes the physical system. This feature of quantum mechanics that allows only for probabilistic predictions concerning measurements in between actual measurements allowed for the development of the QMD.

### BRIEF SUMMARY OF THE INVENTION

With the Quantum Messaging Device (QMD), through systematically varying whether the particular path of a photon emitted into an interferometer is or is not specified (options 1 and 2) at the entrance to the interferometer, one can create a message (i.e., binary information) and send it from one location to another where this message cannot be known by someone in the intervening space between where the message is constructed and where the message is received. There is no relevant measurable difference as regards the photons in the intervening space that is related to the possible path taken by the photon that is tied to whether the particular path of a photon emitted into an interferometer is or is not specified at the entrance to the interferometer (options 1 and 2). (This feature of the QMD is due to principles 1, 2, and 3 noted earlier). Also, attempting to intercept the message (i.e., through altering the operation of the device) in the intervening space between where the message is constructed and where the message is received would likely result in the transmission of the message being disrupted.

The QMD is not a device where the transmission characteristics of the data are uniform from the location where the message is constructed until the location where the message is received and the message content at the source is masked in a systematic way, a way that is known at the receiving end which allows the message to be deciphered. An example of such a device with these characteristics that the QMD does not possess would be the telegraph where a message is constructed at its source in Morse code and the form of this message (i.e., the particular pattern of Morse code containing the message) is the same at the source, at the location where the message is received, and in the middle between the source where the message originates and the location where the message is received. In this conventional scenario, what allows the message not to be known in the middle is a systematic masking (i.e., encryption) of the message at the source where the method of encryption is known at the source and at the intended destination for the message. The method of encryption is not given to anyone in the middle, and therefore in the middle the message cannot be deciphered.

In the QMD, on the other hand, the transmission characteristics themselves are not uniform from beginning to end. In the middle, the message information cannot be known because in the middle there is a uniform set of quantum mechanical predictions for each photon when it travels through the interferometer concerning which possible path the photon will take in this region whether the particular path of a photon emitted into an interferometer is or is not specified at the entrance to the interferometer (options 1 and 2). In contrast, where the message is received, there are different quantum mechanical predictions for the photons that depend on the systematic variation concerning whether the particular path of a photon emitted into an interferometer is or is not specified (options 1 and 2) at the entrance to the interferometer.

The ability to send a message in the manner noted is an extension of the idea in quantum mechanics that between the initial state (which results from a prior measurement) and final state (where a measurement is made) of a quantum system one does not really know precisely what is happening “in the middle.” The quantum wave function allows only predictions of what will occur if a measurement is made. In the absence of a measurement, we have only quantum mechanical predictions that are probabilistic in nature. As noted, in the QMD, these predictions for detecting a photon in the two possible pathways in the intervening space between where the message is constructed and where the message is received are the same regardless of whether the particular path of a photon emitted into an interferometer is or is not specified (options 1 and 2) at the entrance to the interferometer. After the photons leave “the middle” of the device, whether the particular path of a photon emitted into an interferometer is or is not specified (options 1 and 2) at the entrance to the interferometer results in different distribution patterns at the photodetectors.

First, a one source Mach-Zehnder interferometer with half-silvered mirrors as beam splitters BS_M and BS_N (option 1) is presented (FIG. 3).^{10,11} A Mach-Zehnder interferometer has one photon source. The results obtained with this device are well-known. Second, an interferometer where a photon is emitted into a specific path and where the interferometer is otherwise equivalent to the Mach-Zehnder interferometer (option 2) is presented (FIGS. 4, 5). Results obtained with this second device are well-determined. The difference in results between options 1 and 2 concerns the percentage of photons that are detected at photodetectors D1 and D2 after passing through the interferometer. The results obtained in option 1 depend on the phase coherence of the component waves at the ½ silvered surface of the beam splitter BS_N at N placed at the exit of the interferometer and in front of the photodetectors. In option 1, all photons released at the photon source are detected at detector D1. 0 photons are detected at detector D2. In option 2, ½ of the photons initially originating at each of the two possible photon sources are detected at detector D1 and ½ of the photons initially originating at each of the two possible sources are detected at detector D2. The heart of the QMD is that it allows for alternating between: 1) not specifying the particular path of the photon from the beginning of the interferometer at M until just before the exit of the interferometer at N in option 1, and 2) specifying the particular path of the photon from the beginning of the interferometer at M until just before the exit of the interferometer at N in option 2.

### Option 1: the Mach-Zehnder Interferometer

In option 1, the equation for the photon traveling through the Mach-Zehnder interferometer (FIG. 3), before the photon reaches the ½ silvered surface of the second beam splitter BS_N at N in front of the photodetectors D1 and D2 (i.e., from M to N), is:

Ψₚₕₒₜₒₙ=1/√2[ψ_{U}+ψ_{L}] [13]

where ψ_{U} and ψ_{L} are the wave function components for the photon traveling through either the upper arm or the lower arm of the interferometer after the photon passes through, or is reflected off of, the initial beam splitter BS_M. The probability of the photon being detected along the upper arm of the interferometer is equal to the probability of the photon being detected along the lower arm of the interferometer, namely ½.^{12,A}

Taking the second beam splitter BS_N into account, the wave equation for the system is the following:

Ψₚₕₒₜₒₙ=[[−1/√2][1/√2(ψ_{N}_{_{—}}_{D1}+ψ_{N}_{_{—}}_{D2})]]_{from U}+[[1/√2][1/√2(−ψ_{N}_{_{—}}_{D1}+ψ_{N}_{_{—}}_{D2})]]_{from L} [14]

where ψ_{N}_{_{—}}_{D1} and ψ_{N}_{_{—}}_{D2} represent wave function components that the photon travels from N to detector D1 or instead from N to detector D2 after the photon is either reflected off, or passes through, BS_N. The − sign for 1/√2 for path U represents a ½ λ phase difference between ψ_{U} and ψ_{L} from M until just before N due to the possibility of the photon reflecting off the ½ silvered surface of the beam splitter BS_M at M (with the clear glass of this beam splitter behind the ½ silvered surface) into path U in contrast to the possibility of this photon being refracted through BS_M into path L. This reflection off BS_M results in a ½ λ phase shift and the refraction through BS_M does not.

There is a very small constant phase factor k that appears in the possible paths of the photons from the photon source to D1 and D2, as shown in FIG. 3. The constant phase factor k is due to refraction of the photon through the glass of the beam splitters BS_M and BS_N. The two beam splitters are composed of the same material and thus have the same index of refraction. Moreover, the width of each of the beam splitters is the same. (k is associated with the change in path length due to refraction and the different velocity of the photon as it passes through the beam splitter.)

The constant phase change k does not affect distribution patterns of photons at D1 or D2 in option 1 from what the pattern would be in the absence of k. For photons detected at D1, whether the photons traveled path U or path L to N, there is a 1k phase change. For photons detected at D2, whether the photons traveled path U or path L to N, there is a 2k phase change. Between M and N (located on the ½ silvered surface of BS_N) the phase changes due to refraction are the same for path U and path L, namely 1 k. As will be shown, the pattern of k phase changes is the same in options 1 and 2. For these reasons, k is included in the wave function Ψ_{Photon} in option 1 without separate notation.

The negative sign in −ψ_{N}_{_{—}}_{D1} in eqn. 14 is present since there is a phase change of ½ λ for the component wave function of the photon that travels the lower arm of the interferometer (ψ_{L}) and that is reflected at BS_N to detector D1. Calculating out eqn. 14:

Ψₚₕₒₜₒₙ=−ψ_{N}_{_{—}}_{D1} [15]

Taking the absolute square of −ψ_{N}_{_{—}}_{D1} yields the probability P that the photon will be detected at D1. P is 1. In option 1, all photons emitted at the source are detected at D1 due to constructive interference. 0 photons are detected at detector D2 due to destructive interference. The lengths of the two arms of the interferometer from M to N are equal.

### Option 2: Swapping in and Out a Full-Silvered Mirror at the Entrance to the Interferometer

Option 2 also involves an interferometer with a single photon source with the following alteration: The photon source emits photons that travel along only one path of the interferometer and the specific path is determined by swapping in and out of the entrance to the interferometer a full silvered mirror (M_M) as a result of which the photon reflects into one of the two paths. Just as in option 1, the device has full-silvered mirrors (M_Y and M_Z) positioned so that all photons reaching these mirrors from the entrance to the interferometer are reflected to beam splitter BS_N at N at the exit of the interferometer where the photon paths recombine. As in option 1, the lengths of the two arms of the interferometer from M to the ½ silvered surface of BS_N at N are equal.

In option 2, which specific path the photon is emitted into randomly varies over the runs of a set of runs of the QMD. Thus ½ of the photons in the runs of a set are emitted into one of the two paths from M to N and 1/2 of the photons in the runs of a set are emitted into the other path from M to N (FIGS. 4 and 5.

This random emission of photons into one or the other of the interferometer paths is just what happens with the Mach-Zehnder interferometer where the interaction of the photon from the single source with the beam splitter BS_M at M results in the probability that the photon is reflected off the beam splitter BS_M being ½ or instead the probability that the photon passes through BS_M being ½. The difference between the Mach-Zehnder interferometer (option 1) and the swapping in and out of the entrance of the interferometer the full silvered mirror M_M (option 2) is that in option 2 information is available concerning which specific path the photon is taking through the interferometer (because of the swapping in and out of the full silvered mirror at A) and in option 1 this information is not available (because the beam splitter BS_M at M with which the photons interact is a one-half silvered mirror). This difference results in different distributions of photons at the photodetectors located on the paths of the interferometer posterior to the exit of the interferometer over sets of runs of the QMD using either option 1 or option 2.

FIG. 4 shows a photon source in place to send a photon down path U of the interferometer. FIG. 5 shows the same photon source in place to send a photon down path L of the interferometer. A piece of clear glass is inserted along L at the beginning of the interferometer to make the physical conditions in option 2 from M to D1 and D2 like those in option 1. Importantly, in the intervening space from M until N there is no difference as regards the physical conditions for the photon's passage in this area between option 1 or option 2 that would allow someone between M and N to distinguish between options 1 or 2 as regards the flight of the photon from M to N. Furthermore, the piece of clear glass balances the k phase changes for the paths U and L through to D1 and D2 so that the distribution patterns at D1 and D2 are the same as if k was not involved in the passage of the photon from source to D1 or D2.

In option 2, the equations for the photon traveling through the interferometer, before the photon reaches the second beam splitter BS_N in front of the detectors D1 and D2 (i.e., from M to N), are:

Ψₚₕₒₜₒₙ=ψ_{U} [16] [full-silvered mirror inserted at entrance] [shown in FIG. 4]

or

Ψₚₕₒₜₒₙ=ψ_{L} [17] [full-silvered mirror not inserted at entrance]

[shown in FIG. 5]
where ψ_{U} and ψ_{L} are the wave function components for the photon traveling through either the upper arm (U) or the lower arm (L) of the interferometer depending on whether or not the full-silvered mirror M_M is in place at the entrance to the interferometer. Between M and N, the probability of the photon being detected along the upper arm of the interferometer (U) is equal to the probability of the photon being detected along the lower arm of the interferometer (L), namely ½.¹²

Taking the beam splitter BS_N at N into account for Ψₚₕₒₜₒₙ=ψ_{U}[16], Ψₚₕₒₜₒₙ changes to:

Ψₚₕₒₜₒₙ=[−1/√2(ψ_{N}_{_{—}}_{D1}+ψ_{N}_{_{—}}_{D2})]_{from U} [18],

and taking the beam splitter BS_N at N into account for Ψₚₕₒₜₒₙ=ψ_{L}[17], Ψₚₕₒₜₒₙ changes to:

Ψₚₕₒₜₒₙ=[1/√2(−ψ_{N}_{_{—}}_{D1}+ψ_{N}_{_{—}}_{D2})]_{from L} [19]

where ψ_{N}_{_{—}}_{D1} and ψ_{N}_{_{—}}_{D2} represent wave function components that the photon travels from N to detector D1 or instead from N to detector D2 after the photon is either reflected off BS_N at N, or instead is refracted through BS_N through N. As in option 1, the lengths of the two arms of the interferometer from M to the ½ silvered surface of BS_N at N are equal.

There is a very small constant phase factor k that appears in the possible paths of the photons from M to D1 and D2, as shown in FIGS. 4 and 5. The constant phase factor k is due to refraction of the photon through the clear glass near M and the glass of the beam splitter BS_N at N. The constant phase change k does not affect distribution patterns of photons at D1 or D2 in option 2 from what the pattern would be in the absence of k. For photons detected at D1 there is a 1 k phase change along either paths U or L beginning at M. For photons detected at D2 there is a 2 k phase change along either paths U or L beginning at M. The pattern of k phase changes is the same in options 1 and 2. For these reasons, k is included in the wave function Ψₚₕₒₜₒₙ in option 2 without separate notation.

The path length of U between M and N in option 1 is the same as the path length of U between M and N in option 2, and the path length of L between M and N in option 1 is the same as the path length of L between M and N in option 2. It is the fact that the path length of U between M and N is the same in options 1 and 2 and the path length of L between M and N is the same in options 1 and 2 which does not allow path length along either arm of the interferometer between M and N to distinguish whether the QMD is operating in option 1 (i.e., 1 photon source in a Mach-Zehnder interferometer where a particular path is not specified between M and N) or option 2 (i.e., 1 photon source with a particular path specified from M to N). The path lengths of U and L between M and N are the same in option 1 and option 2.

The − sign before 1/√2 in eqn. 18 is due to a ½ λ phase difference between ψ_{U} and ψ_{L} that results from the photon reflecting off the full-silvered mirror M_M at M into path U in one setup in option 2 and the possibility of this photon being refracted through the clear glass at the entrance to path L when it enters path L in the other setup in option 2 where the full-silvered mirror M_M is not in place at the entrance to the interferometer. The negative sign in −ψ_{N}_{_{—}}_{D1} in eqn. 19 is present since there is a phase change of ½ λ for the component wave function of the photon that travels the lower arm of the interferometer (ψ_{L}) and that is reflected off the ½ silvered surface of BS_N at N to D1. In option 2, these changes in phase do not affect the result that of the photons traveling over U arrive at D1 and ½ at D2 and of the photons traveling L arrive at D1 and ½ at D2 since the particular path of the particles is specified. On the other hand, in option 1, where the particular path of the photon is not specified between M and N, these phase changes are the basis for constructive interference found at D1 and destructive interference found at D2.

### Characteristics of the Device

In the intervening area between M and N in FIGS. 3, 4, and 5, one cannot distinguish between the probabilities of the photon taking either of the different possible paths (path U or path L) in this area to determine whether option 1 or option 2 was employed. If we cover the photon source and associated apparatus in options 1 and 2 (as in FIG. 6), then option 1 looks like option 2 in terms of the probable paths of the photons: 1) after the photon enters the different arms of the interferometer at M and 2) before the photon reaches BS_N at N as regards the probabilities of detecting the photon along either one or the other of the arms of the interferometer “in the middle” between positions M and N. (The area just posterior to the beginning of the interferometer at M would also need to be inaccessible because of the use of the beam splitter BS_M in option 1 and a piece of clear glass and the full silvered mirror M_M in option 2.) If a measurement were made to determine the path of the photon between M and N, the probability of detecting a photon along either the upper or lower arm (i.e., U or L) in either option 1 or option 2 would be ½. Knowing the specific path the photon was emitted into in option 2 does not help to differentiate between options 1 and 2 regarding the path of the photon after the photon reaches M and before the photon reaches the ½ silvered surface of beam splitter BS_N at N. Nonetheless, different overall results are obtained in terms of detecting photons at detectors D1 and D2 in option 2 than in option 1 with the Mach-Zehnder interferometer. After the photon reaches the beam splitter BS_N at N, knowing the specific path the photon was emitted into in option 2 does help to differentiate the situation regarding the paths of the photon from N to the detectors D1 and D2 as opposed to not knowing the specific path the photon was emitted into that is the case in option 1.

### Message Construction

If one were to alternate between options 1 and option 2 in a systematic manner, one could construct a message at the entrance to the interferometer at M and send it to the detectors after N where the message can be known (FIG. 7). There would be no discernible difference as regards the probable paths of the photons in the intervening space between M and N as the message is transmitted between these two points that would allow the message to be known by someone in this intervening space. The message would be constructed and transmitted by:
1. Equating a bit of binary value 0 with a pattern of results found when option 1, where a beam splitter (i.e., a ½ silvered mirror) is inserted at the entrance to the interferometer (at M), is used in a set of runs (e.g., 100) so that it can be reliably determined that the distribution of the photons at the detectors is that associated with option 1. (All of the photons are detected at D1, and 0 photons are detected at D2.)
2. Equating a bit of binary value 1 with a pattern of results found when option 2, where a full-silvered mirror is randomly swapped in and out of the entrance (at M) to the interferometer and a piece of clear glass is inserted along path L at the beginning of the interferometer, is used in a set of runs (e.g., 100) so that it can be reliably determined that the distribution of the photons at the detectors is that associated with option 2. (½ of the photons are detected at D1, and ½ of the photons are detected at D2.)
   A sequence of binary bits could be obtained in sets composed of 100 runs performed sequentially in option 1 and option 2.

Observers situated at detectors D1 and D2 and the photon counter, bit assembler, and bit collector (FIG. 7) would know the binary message sent from before position M where, as noted, the ½ silvered mirror BS_M (option 1) and the full silvered mirror M_M and piece of clear glass (option 2) can be changed in different sets of runs of the QMD to change the bit value being sent. Those individuals situated before position M, who design the message that is constructed through running sets using option 1 and option 2 to develop the bits making up the message, know the predicted pattern of results concerning the photon detections at detectors D1 and D2. Anyone “in the middle” between M and N who is not privy to the specific pattern of sets run under option 1 and option 2 to construct and send the binary message cannot predict the results of the pattern of photon detections at D1 and D2. These individuals are limited to detecting in which path of the interferometer (either path U or path L) the photon is in between M and N (in the “in between” area) if a measurement of the photon's position is made. The prediction concerning the probability of detecting a photon in either path of the interferometer between M and N in option 1 or option 2 in the space between M and N is the same, ½.

Attempting to intercept the message (i.e., altering the operation of the device) in the intervening space between where the message is constructed and where the message can be received (i.e., between M and N) would likely result in the message being eliminated through phase decoherence and thus not being detectable. One could detect the specific path over which the photon traveled between M and N, but in so doing one would disrupt the phase coherence of the wave functions representing the photon. If one were somehow able to make this measurement of the position of the photon between M and N and then send the photon on its way through the remainder of the interferometer, the results for both option 1 and option 2 at the detectors would be the same, ½ of the photons would be detected at detector D1 and ½ of the photons would be detected at detector D2.

### Footnotes

^{A}The beam splitters BS_M and BS_N are ½ silvered mirrors composed of glass with the silver located along 1 surface of the glass. Reflection of the photon off the ½ silvered surface of such a beam splitter where the ½ silvered surface is the initial interaction surface off the photon with the beam splitter results in a ½ λ phase change because the substance on the other side of this surface (the glass of the beam splitter) has a higher index of refraction than air (or vacuum) through which the photon passes to interact with the initial surface of the beam splitter (e.g., reflection of photon off BS_M in FIG. 3). Where the photon first passes through the beam splitter and reflects off the ½ silvered surface on the “far” side of the beam splitter, there is no phase change of ½ λ due to reflection because the substance on the other side of this surface (air or perhaps a vacuum) has a lower index of refraction than the glass of the beam splitter (e.g., reflection of photon from Y off BS_N in FIG. 3). Reflection off a full silvered mirror results in a ½ λ phase change (e.g., M_Y and M_Z in FIG. 3).

### REFERENCES

¹R. P. Feynman, R. B. Leighton, and M. Sands. The Feynman Lectures on Physics: Quantum Mechanics (vol. 3). Reading: Massachusetts: Addison-Wesley, 1965.
²Liboff, R. L. Introductory Quantum Mechanics (2^{nd} ed.). Reading: Massachusetts: Addison-Wesley, 1993.
³M. O. Scully, B. G. Englert, and H. Walther, “Quantum optical tests of complementarity.” Nature (London), 351, 111-116, 1991.
⁴N. Bohr, Discussion with Einstein on epistemological problems in atomic physics. In P.A. Schilpp, Albert Einstein: Philosopher-scientist (vol. 1) (pp. 199-241). LaSalle Illinois: Open Court, 1949/1970.
⁵Einstein, A., Podolsky, B., & Rosen, N. Can quantum-mechanical description of physical reality be considered complete? Physical Review, 47, 777-780, 1935.
⁶Bell. J. S., On the Einstein-Podolsky-Rosen Paradox. Physics, 1, 195-200, 1964. In Quantum Theory and Measurement (Wheeler, J. A., and Zurek, W. H., eds.) Princeton: Princeton University Press, 1983, pp. 403-408.
⁷Aspect, A., Dalibard, J., & Roger, G. Experimental test of Bell's inequalities using time-varying analyzers. Physical Review Letters, 49, 1804-1807, 1982.
⁸Aspect, A., Grangier, P., & Roger, G. Experimental realization of Einstein-Podolsky-Rosen-Bohm gedankenexperiment: A new violation of Bell's inequalities. Physical Review Letters, 49, 91-94, 1982.
⁹Rohrlich, F. Facing quantum mechanical reality. Science, 221(4617), 1251-1255, 1983.
¹⁰D. M. Harrison, Mach-Zehnder Interferometer. http://www.upscale.utoronto.ca/Generallnterest/Harrison/MachZehnd, 2007.
¹¹Wikipedia, Mach-Zehnder Interferometer. http://en.wikipedia.org/wiki/Mach-Zehnder_Interferometer, Aug. 29, 2006.
¹²Epstein, P. S. “The reality problem in quantum mechanics.” American Journal of Physics, 13, 127-136, 1945.

### BRIEF DESCRIPTION OF THE SEVERAL VIEWS OF THE DRAWING

FIG. 1—Overview of thought experiment (i.e., gedankenexperiment) in which the distribution of electrons passing through an anchored double-slit screen indicates interference in the wave functions of the electrons. The interference pattern depends on taking the sum of the amplitudes for the electron to pass through each slit and squaring the resulting amplitude. Considered in classical approximation, it would appear that the electron passes through both slits in the double-slit screen.

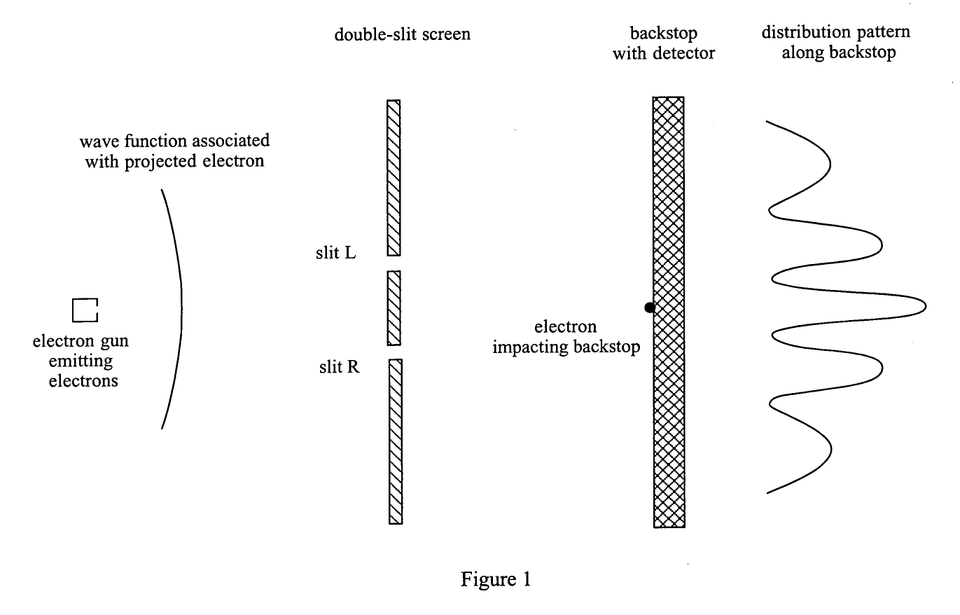

FIG. 2—Overview of thought experiment (i.e., gedankenexperiment) in which the distribution of electrons passing through a double-slit screen on rollers provides on its way to the detection screen.

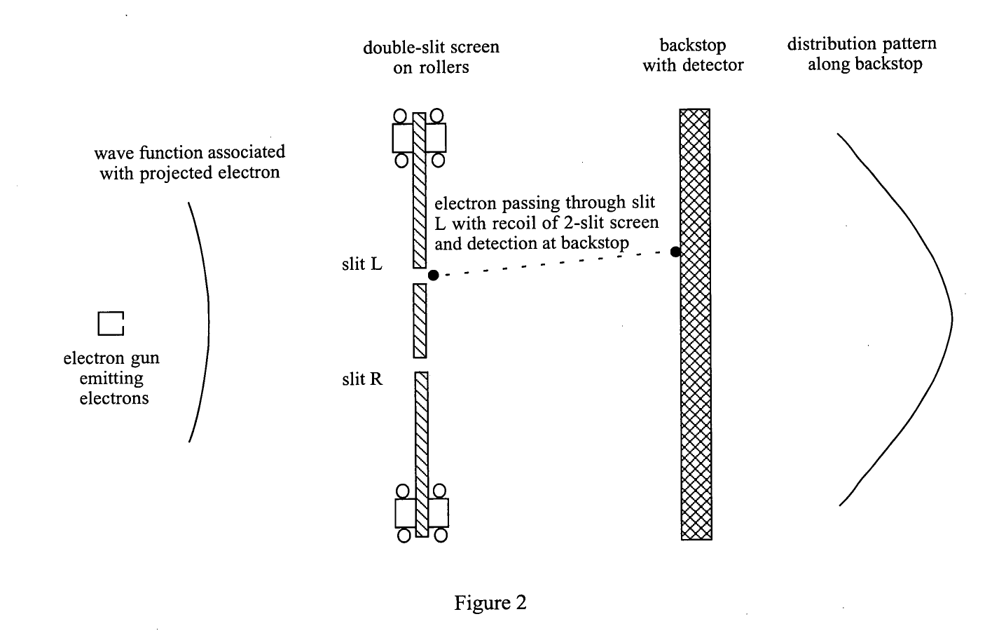

FIG. 3—A Mach-Zehnder interferometer that is one of two options (option 1) in the QMD.

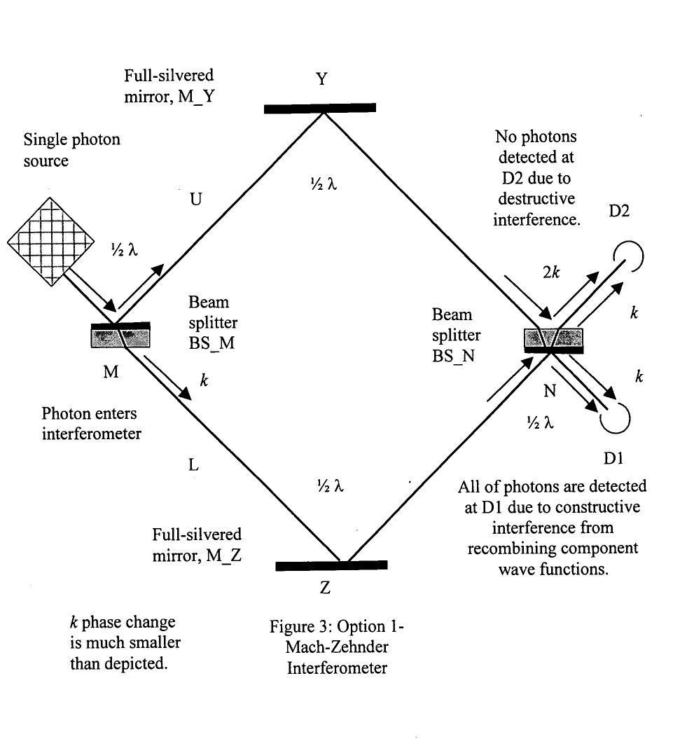

FIG. 4—A single photon source that emits a photon into the upper path (U) of the interferometer (option 2) in the QMD.

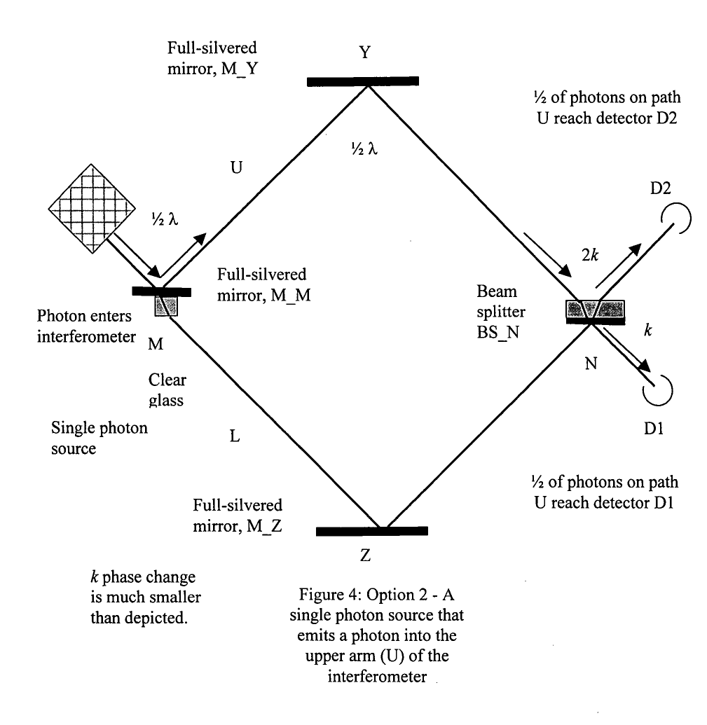

FIG. 5—A single photon source that emits a photon into the lower path (L) of the interferometer (option 2) in the QMD.

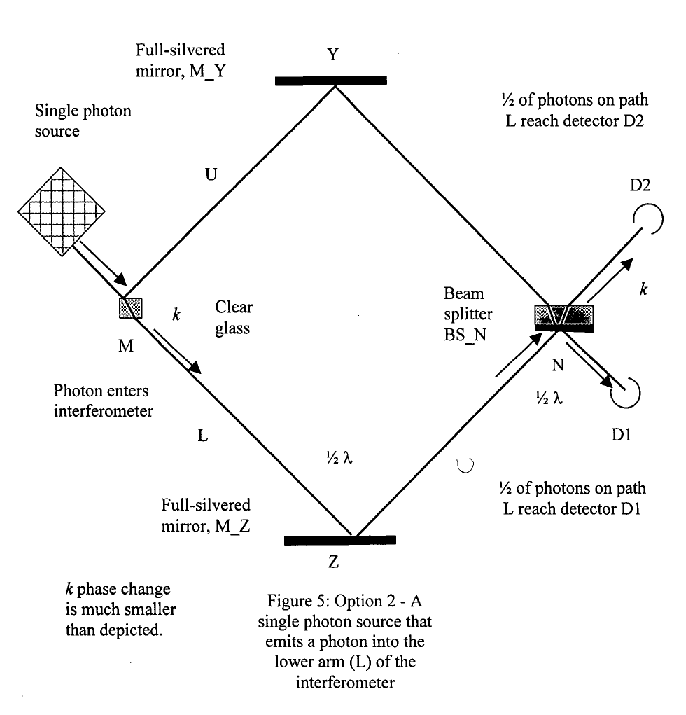

FIG. 6—Depiction of the equivalence of the probabilities of detecting photons between the entrance to and exit from the interferometer along either path U or path L for options 1 and 2.

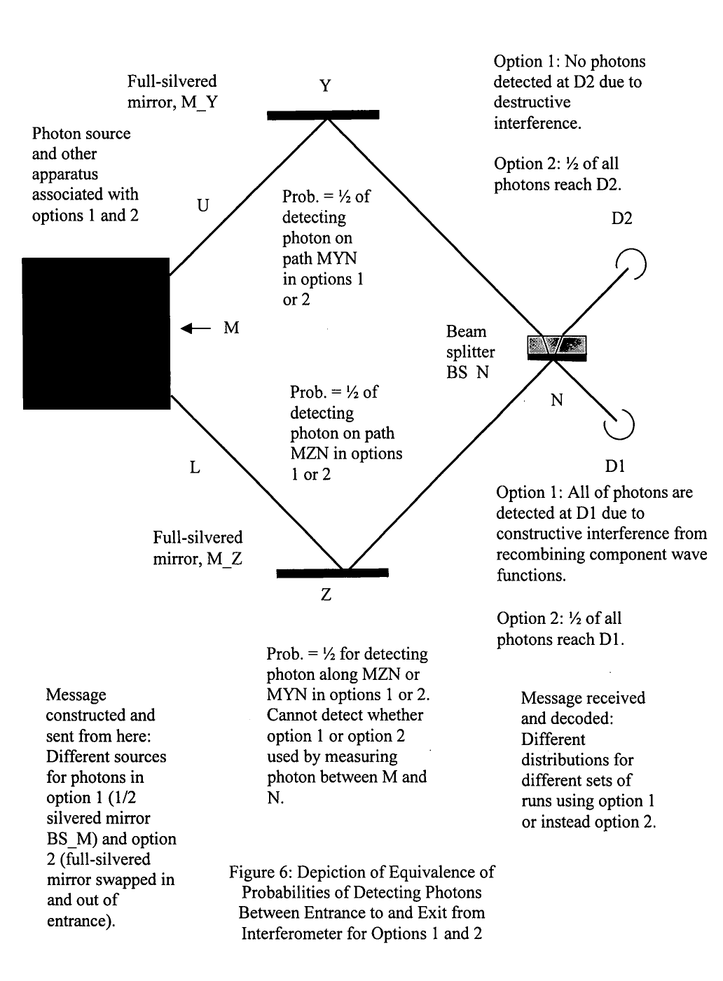

FIG. 7—Depiction of options 1 and 2 that can be put in place for a set of runs of the QMD. This switching between options 1 and 2 for sets of 100 runs each provides different results at detectors D1 and D2 for options 1 and 2 that allow for associating a binary bit value of 0 to the results for a set of runs in option 1 and a binary bit value of 1 to the results for a set of runs in option 2.

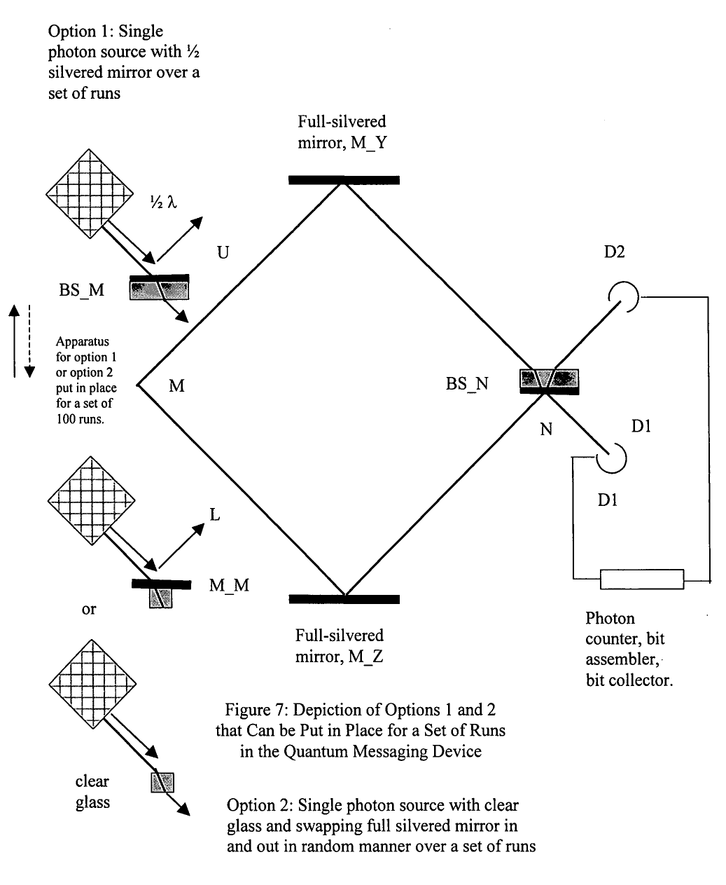

### DETAILED DESCRIPTION OF THE INVENTION

With the Quantum Messaging Device (QMD), through systematically varying whether the particular path of a photon emitted into an interferometer is or is not specified (options 1 and 2), one can create a message (i.e., binary information) and send it from one location to another where this message cannot be known in the intervening space between where the message is constructed and where the message is received. The QMD is not a device where the transmission characteristics of the data are uniform from beginning to end and the message content is masked in a systematic way, a way that is known at the receiving end which allows the message to be deciphered. Instead, in the very transmission of the binary data, there are no relevant measurable differences as regards the photons carrying the message in the intervening space between where the message is constructed and where the message is received. Most importantly, the probabilities of detecting the photons traveling through the interferometer between the entrance and exit points are the same (i.e., ½) whether the particular path of a photon emitted into an interferometer is or is not specified (options 1 and 2) at the entrance to the interferometer. Nonetheless, the probabilities of detecting the photons at either of the two detectors situated posterior to the exit from the interferometer (and thus the distributions of these photons at the two photodetectors) do depend on whether the particular path of a photon emitted into an interferometer is or is not specified (options 1 and 2, respectively) at the entrance to the interferometer.

That the probabilities of detecting the photons at either of the two detectors are different depending on whether a set of runs is conducted using option 1 or option 2 allows for message construction at the entrance to the interferometer and message reception at the detectors and analyzers situated posterior to the exit of the interferometer. In the QMD, the transmission characteristics in transferring information are not uniform from beginning to end. In the middle, the information cannot be known because there is a uniform set of predictions for all the photons when they are traveling through the interferometer, regardless of whether or not the particular path of a photon emitted into an interferometer is or is not specified (options 1 and 2, respectively) at the entrance to the interferometer.

Also, attempting to intercept the message in the intervening space between where the message is constructed and where the message can be received would likely result in the transmission of the message being disrupted. The ability to send a message in the manner noted is an extension of the idea in quantum mechanics that between the initial state and final state of a quantum system one does not really know what is happening “in the middle.” The quantum wave function allows predictions of what will occur if a measurement is made. In the absence of a measurement, there are only quantum mechanical predictions that are probabilistic in nature. In the device presented, these predictions for detecting a photon are the same in the two possible pathways in the intervening space between where the message is constructed and where the message can be received irrespective of whether or not the particular path of a photon emitted into an interferometer is or is not specified (options 1 and 2) at the entrance to the interferometer.

Yet after a photon exits the interferometer and enters one of two pathways leading to a detector, the probabilities of detecting a photon along either one of these paths do differ depending on whether or not the particular path of the photon is specified over the middle of the interferometer between M and N at the entrance to the interferometer M. That the probabilities of detecting a photon along either one of these paths at the detectors do differ depending on whether or not the particular path of the photon is specified over the middle of the interferometer allows the sent message developed at the entrance to the interferometer to be known at the detectors, one of which is located on each of the two paths leaving the exit of the interferometer at N.

This QMD uses the following quantum mechanical principles to accomplish this messaging:
1) Superposition of quantum states, including the possibility of constructive and destructive interference arising from this superposition;
2) The quantum mechanical wave function provides the basis for making probabilistic predictions of measurement outcomes;
3) Between the initial state and final state of a quantum system one does not really know what is happening “in the middle.” The quantum wave function allows predictions of what will occur if a measurement is made. In the absence of a measurement, there are only quantum mechanical predictions that are probabilstic in nature.

The device employs these principles in a way that produces a non-classical result that emphasizes the informational character of the wave function in quantum theory. The invention consists of the following elements and operates in the following way:
1. Through systematically varying whether the particular path of a photon emitted into an interferometer is or is not specified (options 1 and 2) in sets of runs of the QMD, one can create a message (i.e., binary information) and send it from one location to another where this message cannot be known in the intervening space between the entrance to the interferometer where the message is constructed and the exit of the interferometer after which the message is received. There are no relevant measurable differences between options 1 and 2 as concerns the photons that bear the message information that allow for knowing the message in this intervening space.
2. The probability of detecting the photon along one path of the interferometer in both options 1 and 2 before the photon reaches the ½ silvered surface of the beam splitter located at the exit of the interferometer is ½ and the probability of detecting the photon along the other path of the interferometer in both options 1 and 2 before the photon reaches the ½ silvered surface of the beam splitter located at the exit of the interferometer is ½.
3. Attempting to intercept the message in the intervening space between where the message is constructed and where the message is received would likely result in the transmission of the message being disrupted.
4. The QMD can systematically vary whether or not the particular path of the photon emitted into the interferometer from the entrance to the exit of the interferometer is or is not specified with the result that different distributions of photon detections are produced at the photodetectors located on the paths of the interferometer posterior to the exit of the interferometer over sets of runs, with one particular distribution associated with not specifying the particular photon path at the entrance to the interferometer (option 1) and another particular distribution associated with specifying the particular photon path at the entrance to the interferometer (option 2). In option 1, there are 0 photons at one of the two photodetectors (due to destructive interference) and all of the photons are detected at the other photodetector (due to constructive interference). In option 2, ½ of the photons emitted from the photon source are detected at one photodetector and ½ of the photons are detected at the other photodetector.
5. Each of the 2 different photon distributions at the photodetectors can be uniquely associated with bit value “0” or “1”, which means that option 1 and option 2 that can be employed in the device to produce the different distributions can also be uniquely associated with bit value “0” or “1”.
6. There is an interferometer where there are two paths along which a photon entering the interferometer can travel to a point where the paths intersect and there is a 50-50 beam splitter (BS_N) located at the exit of the interferometer at N with the following conditions: a) the components of the interferometer are designed to allow for phase coherence of wave function components of a photon as the photon travels through the interferometer, if more than one wave component exists, b) if wave function components of the photon recombine at BS_N at N, due to coherence among the wave function components, interference is the result of the photon's interaction with the ½ silvered surface of the beam splitter BS_N and the effects of this interference are observed at the subsequent photon detectors located along extensions of the two paths of the interferometer that originate at the beam splitter BS_N at the exit of the interferometer.
7. There are two photodetectors where one of the photodetectors is located along one of the paths of the interferometer posterior to the exit of the interferometer and the other photodetector is located along the other path of the interferometer posterior to the exit of the interferometer.
8. There is a photon source anterior to the entrance to the interferometer.
9. There are two apparatuses that can be set in place at the entrance to the interferometer and posterior to the photon source where either: a) (option 1) a 50-50 beam splitter BS_M (a half-silvered mirror) is set in place at the entrance to the interferometer with which the photons emitted from the photon source interact for a set of runs and at this beam splitter (BS_M), a photon either is refracted through BS_M into one path of the interferometer (e.g., the lower path) or the photon is reflected off BS_M into the other path of the interferometer (e.g., the upper path), or b) (option 2) a piece of clear glass is inserted into the beginning of the lower path of the interferometer, and a full-silvered mirror (M_M) is swapped in and out of the entrance to the interferometer in a random manner, in a set of runs of the QMD such that when the mirror is not in place at the entrance to the interferometer a photon from the photon source is refracted through the piece of clear glass into a specific interferometer path (e.g., the lower path) and when the mirror is in place at the entrance to the interferometer a photon from the photon source is reflected into the other specific interferometer path (e.g., the upper path); the two apparatuses are set so that in both options 1 and 2 the photon is refracted into the same path of the interferometer or the photon is reflected into the same path of the interferometer.
10. In option 2, a piece of clear glass at the beginning of the lower path of the interferometer produces a constant phase change k through refraction of a photon passing through it equal to that found in option 1 where the photon is refracted through the beam splitter BS_M at the entrance to the interferometer into the lower path of the interferometer (the clear glass is equal in width to the width of BS_M and the clear glass is composed of the same material as BS_M [the index of refraction of the clear glass and of the material of which BS_M is composed are the same]).
11. The beam splitter BS_N at N at the exit to the interferometer and the beam splitter BS_M at M at the entrance to the interferometer in option 1 are composed of the same materials and constructed in the same manner.
12. For options 1 and 2: 1) the path lengths of the upper path through the interferometer (MYN) for the photons from the entrance to the interferometer (M) to the ½ silvered mirror of the beam splitter BS_N at N at the exit to the interferometer are equal, and 2) the path lengths of the lower path through the interferometer (MZN) for the photons from the entrance to the interferometer (M) to the ½ silvered mirror of the beam splitter BS_N at N at the exit to the interferometer are equal.
13. There is a photon counter that tallies the number of photons detected at each of the photodetectors located on the paths posterior to the exit of the interferometer over a set of runs using either option 1 or 2.
14. There is a bit assembler that assembles data obtained by a photon counter for a set of runs of the QMD (each set using either option 1 or option 2) and associates either a bit value of “0” or “1” with the distribution of photons at both detectors in that set of runs.
15. There is a bit collector that collects the bits assembled by a bit assembler as the bits are assembled and this bit collection results in the binary message sent with the QMD from the entrance to the interferometer.

1. I claim a device that through systematically varying whether the particular path of a photon emitted into an interferometer is or is not specified (options 1 and 2, respectively) over sets of runs of the device, one can create a message (i.e., binary information) and send it from one location to another where this message cannot be known in the intervening space between the entrance to the interferometer where the message is constructed and the exit of the interferometer after which the message is received.

2. I claim that for the device specified in claim 1 there are no relevant measurable differences as concerns the photons that bear the message information that allow for knowing the message in this intervening space.

3. I claim that for the device specified in claim 1 the probability of detecting the photon along one path of the interferometer in both options 1 and 2 before the photon reaches the ½ silvered surface of the beam splitter located at the exit of the interferometer is ½ and the probability of detecting the photon along the other path of the interferometer in both options 1 and 2 before the photon reaches the ½ silvered surface of the beam splitter located at the exit of the interferometer is ½.

4. I claim regarding the device noted in claim 1 that attempting to intercept the message in the intervening space between where the message is constructed and where the message is received would likely result in the transmission of the message being disrupted.

5. I claim the device noted in claim 1 can systematically vary whether the particular path of the photon emitted into the interferometer from the entrance to the exit of the interferometer is or is not specified with the result that different distributions of photon detections are produced at the photodetectors located on the paths of the interferometer posterior to the exit of the interferometer over sets of runs, with one particular distribution associated with not specifying the particular photon path at the entrance to the interferometer (option 1) and another particular distribution associated with specifying the particular photon path at the entrance to the interferometer (option 2).

6. I claim concerning the device noted in claims 1 through 5 that in option 1 there are 0 photons at one of the two photodetectors (due to destructive interference) and all of the photons are detected at the other photodetector (due to constructive interference). In option 2, ½ of the photons emitted from the photon source are detected at one photodetector and ½ of the photons are detected at the other photodetector.

7. I claim that for the device noted in claims 1 through 6 each of the 2 different photon distributions at the photodetectors can be uniquely associated with bit value “0” or “1”, which means that options 1 and 2 that can be employed in the device to produce the different distributions can also be uniquely associated with bit value “0” or “1”.

8. I claim that the device described in claim 1 is further comprised of an interferometer where there are two paths along which a photon entering the interferometer can travel to a point where the paths intersect and there is a 50-50 beam splitter (BS_N) located at the exit of the interferometer at N with the following conditions: a) the components of the interferometer are designed to allow for phase coherence of wave function components of a photon as the photon travels through the interferometer, if more than one wave component exists, b) if wave function components of a photon recombine at BS_N at N, due to coherence among the wave function components, interference is the result of the photon's interaction with the ½ silvered surface of the beam splitter BS_N and the effects of this interference are observed at the subsequent photon detectors located along extensions of the two paths of the interferometer that originate at the beam splitter BS_N at the exit of the interferometer.

9. I claim the device described in claim 1 is further comprised of two photodetectors where one of the photodetectors is located along one of the paths of the interferometer posterior to the exit of the interferometer and the other photodetector is located along the other path of the interferometer posterior to the exit of the interferometer.

10. I claim the device described in claim 1 is further comprised of a photon source anterior to the entrance to the interferometer.

11. I claim the device described in claim 1 is further comprised of two apparatuses that can be set in place at the entrance to the interferometer and posterior to the photon source where either: a) (option 1) a 50-50 beam splitter BS_M (a half-silvered mirror) is set in place at the entrance to the interferometer with which the photons emitted from the photon source interact for a set of runs and at this beam splitter (BS_M), a photon either is refracted through BS_M into one path of the interferometer (e.g., the lower path) or the photon is reflected off BS_M into the other path of the interferometer (e.g., the upper path), or b) (option 2) a piece of clear glass is inserted into the beginning of the lower path of the interferometer, and a full-silvered mirror (M_M) is swapped in and out of the entrance to the interferometer in a random manner, in a set of runs of the QMD such that when the mirror is not in place at the entrance to the interferometer a photon from the photon source refracts through the piece of clear glass into a specific interferometer path (e.g., the lower path) and when the mirror is in place at the entrance to the interferometer a photon from the photon source is reflected into the other specific interferometer path (e.g., the upper path); the two apparatuses are set so that in both options 1 and 2 the photon is refracted into the same path of the interferometer or the photon is reflected into the same path of the interferometer.

12. I claim concerning the device described in claim 1 that in option 2 a piece of clear glass at the beginning of the lower path of the interferometer produces a constant phase change k through refraction of a photon passing through it equal to that found in option 1 where the photon is refracted through the beam splitter BS_M at the entrance to the interferometer into the lower path of the interferometer (the clear glass is equal in width to the width of BS_M and the clear glass is composed of the same material as BS_M [the index of refraction of the clear glass and of the material of which BS_M is composed are the same]).

13. I claim concerning the device described in claim 1 that the beam splitter BS_N at the exit to the interferometer and the beam splitter BS_M at the entrance to the interferometer in option 1 are composed of the same materials and constructed in the same manner.

14. I claim the device described in claims 1 through 8 and 11 is further characterized by, for options 1 and 2: 1) the path lengths of the upper path through the interferometer (MYN) for the photons from the entrance to the interferometer (M) to the ½ silvered mirror of the beam splitter BS_N at N at the exit to the interferometer are equal, and 2) the path lengths of the lower path through the interferometer (MZN) for the photons from the entrance to the interferometer (M) to the ½ silvered mirror of the beam splitter BS_N at N at the exit to the interferometer are equal.

15. I claim concerning the device described in claim 1 is further comprised of a photon counter that tallies the number of photons detected at each of the photodetectors located on the paths posterior to the exit of the interferometer over a set of runs of photons using either option 1 or 2.

16. I claim the device described in claim 1 is further comprised of a bit assembler that assembles data obtained by a photon counter for a set of runs of the QMD (each set using either option 1 or option 2) and associates either a bit value of “0” or “1” with the distribution of photons at both detectors in that set of runs.

17. I claim the device described in claim 1 is further comprised of a bit collector that collects the bits assembled by a bit assembler as the bits are assembled and this bit collection results in the binary message sent with the QMD from the entrance of the interferometer.
